(19) United States
(12) Patent Application Publication
(10) Pub. No.: US 2006/0104400 A1
(43) Pub. Date: May 18, 2006

(54) Process and device for analysis of radioactive objects

(76) Inventors: Abdallah Lyoussi, Manosque (FR); Raymond Pasquali-Barthelemy, Saint Crepin (FR); Emmanuel Payan, Manosque (FR); Anne-Cecile Raoux, Condat (FR)

Correspondence Address: PEARNE & GORDON LLP, 1801 EAST 9TH STREET, SUITE 1200, CLEVELAND, OH, 44114-3108, US

(21) Appl. No.: 11/314,558

(22) Filed: Dec. 21, 2005

Related U.S. Application Data
(63) Continuation of application No. 10/872,317, filed on Jun. 18, 2004.
Application No. 10/872,317 is a continuation of application No. 09/719,116, filed on Apr. 9, 2001, now abandoned.

(30) Foreign Application Priority Data
Apr. 8, 1999 (FR) 99 04396

(51) Int. Cl. G21G 1/06

(52) U.S. Cl. 376/159

(57) ABSTRACT

According to the invention, an object (2) and particularly a radioactive waste package that may contain fissile isotopes and/or fertile isotopes, is analyzed by irradiating the object by thermal, epithermal and fast neutrons resulting from a series of initial fast neutron pulses, the prompt and delayed neutron signals emitted by the object after each pulse are measured, these signals are accumulated, and the contribution Sp of prompt neutrons originating form thermal fission and the contribution Sr of delayed neutrons originating from thermal, epithermal and fast fission are determined from this sum of all signals, and the quantity of each isotope is determined using Sp and Sr and additional information about the isotope quantites.

### CROSS-REFERENCE TO RELATED APPLICATIONS

This application is a continuation of U.S. patent application Ser. No. 10/872,317 filed Jun. 18, 2004, now pending, which is a continuation of U.S. patent application Ser. No. 09/719,116 filed Apr. 9, 2001, which is a §371 of PCT/FR2000/00848 filed Apr. 5, 2000.

### TECHNICAL FIELD

This invention relates to a process and a device for analyzing radioactive objects that use a neutronic measurement of these objects.

This invention can be used to analyze these objects non-destructively (in other words without affecting the physical integrity of the objects) by making active measurements (in other words controlled by external radiation) on these objects.

In particular, the invention is applicable to control of the radioactive product treatment process and charaterization of the contents of radioactive waste packages. These packages are containers, usually made of concrete or steel, in which radioactive waste, possibly previously coated in a matrix, is placed.

The invention is particularly applicable to the analysis of the fissile material and/or fertile material contained in these radioactive waste packages in order to non-destructively determine the quantities of some chemical elements present in this waste.

It is applied directly in installations using active non-destructive analysis techniques. In particular, the analysis of the fissile material and/or the fertile material is a means of quantifying the mass of residual fuel.

### STATE OF PRIOR ART

Several measurement methods have been studied in order to non-destructively determine the quantity of some fissile isotopes contained in a waste package, including the neutronic interrogation technique by means of 14 MeV neutrons produced by an appropriate generator.

More particularly, measurement of prompt neutrons and delayed neutrons produced by thermal fission of the fissile material present in the waste package, is described in document U.S. Pat. No. 4,483,816 (J. T. Caldwell et al).

In general, interrogation of an object by a pulsed flux of thermal neutrons is used to identify the presence of fissile material within this object. This type of method is usually used to measure fissile isotopes, namely uranium 235, plutonium 239 and plutonium 241. However, interpretation of the measurements requires prior knowledge of the isotopic composition of the fissile material.

With the technique described in the document mentioned above, the main fissile isotopes thus characterized are uranium 233, uranium 235 and plutonium 239. The various isotopes are quantified by the use of prompt and delayed signals originating from thermal neutrons. Two linear equations are then obtained. A third equation is obtained by measuring coincidences on passive neutrons (in other words neutrons emitted naturally by the material). Therefore, it is possible to calculate the various masses of fissile isotopes mentioned above, present in the object to be measured, provided that several calibration coefficients (previously calculated) are known.

Nevertheless, this technique does not give any information about the presence and quantity of fertile material such as uranium 238 in the object to be analyzed.

### DESCRIPTION OF THE INVENTION

The purpose of this invention is to correct this disadvantage.

The characterization of fissile and fertile materials requires the use of an interrogating flux of thermal, epithermal and fast neutrons, since the fission threshold of uranium 238 is located at an energy of about 1 MeV. Furthermore, the contribution of uranium 238 to the measured neutronic signal can only be used for delayed neutrons emitted by fission fragments of uranium 238. Thus, the measured prompt signal corresponds to neutrons produced by thermal fission (fissile material) and the delayed signal corresponds to neutrons produced by thermal and fast fission (fissile and fertile materials).

This invention combines thermal, epithermal and fast interrogation with detection of prompt and delayed neutrons in order to characterize the fissile and/or fertile material that could be present in an object to be measured.

More precisely, this invention relates to a process for analyzing an object, particularly a radioactive waste package, that might contain a fissile material or a fertile material or both, the fissile material comprising M fissile isotopes and the fertile material comprising N fertile isotopes, where M and N are integer numbers equal to at least 1, this process being characterized in that:
the object is irradiated by a neutron flux formed of thermal, epithermal and fast neutrons and resulting from a sequence of initial pulses of fast neutrons, the thermal neutrons causing fission in the fissile material and the epithermal and fast neutrons causing fission in the fissile material and in the fertile material,
the prompt and delayed neutronic signals emitted by the object after each pulse are measured, and these signals are accumulated to obtain the sum of all signals after the last pulse,
this sum is used to determine the contribution Sp of prompt neutrons produced by thermal fission and the contribution Sr of delayed neutrons produced by thermal, epithermal and fast fissions,
Sp and Sr are expressed as linear combinations 0o the quantities of M+N isotopes, the coefficients of these linear combinations being previously determined by calibration, and
the quantity of each of the M+N isotopes is determined from Sp and Sr thus expressed and at least M+N-2 additional items of information about quantities of M+N isotopes.

For example, this additional information may consist of correlations between the quantities of M+N isotopes.

According to one particular embodiment of the process according to the invention, the fissile and fertile materials contain uranium 235, uranium 238, plutonium 239 and plutonium 241.

This invention also relates to a device for analyzing an object, particularly a radioactive waste package, that may contain fissile material or fertile material or both, the fissile material containing M fissile isotopes and the fertile material containing N fertile isotopes, where M and N are integer numbers equal to at least 1, this device being characterized in that it comprises:
means of irradiating the object by a neutron flux consisting of thermal, epithermal and fast neutrons and resulting from a sequence of initial fast neutron pulses, the thermal neutrons causing fission in the fissile material and the enithermal and fast neutrons causing fission in the fissile material and in the fertile material,
means of counting neutrons, designed to measure prompt and delayed neutronic signals emitted by the object after each pulse, and
means of processing the signals thus measured, designed to accumulate these signals and, after the last pulse, to obtain the sum of all the signals, to use this sum to determine the contribution Sp of prompt neutrons produced by thermal fission and the contribution Sr of delayed neutrons produced by thermal, epithermal and fast fission, and to use Sp and Sr to determine the quantity of each of the M+N isotopes and at least M+N-2 additional items of information related to the quantities of M+N isotopes, expressing Sp and Sr as linear combinations of these quantities, the coefficients of these linear combinations being determined beforehand by calibration.

According to a preferred embodiment of the device according to the invention, the irradiation means comprise:
at least one source of fast neutrons operating in pulsed mode and,
means of thermalizing these fast neutrons.

Preferably, the thermalization means comprise a containment that includes a central area in which the object will be placed and in which at least three sides are delimited by a thickness of moderator material, the neutron source being placed on a fourth side of this containment and the neutron counting means being placed on the three sides between the central area and the thickness of moderator material, a thickness of the multiplier material being provided between the central area and the neutron source and between the central area and neutron counting means.

Each neutron counting means may also be surrounded by a thickness of neutron poison material.

Each neutron counting means may also be surrounded by a moderator material.

The device according to the invention may also comprise a wall made of neutron poison and moderator materials that delimits the fourth side of the containment, the thickness corresponding to the multiplier material being between this wall and the central area.

The device according to the invention may also comprise means of rotating the object within the central area of the containment.

### BRIEF DESCRIPTION OF THE DRAWINGS

This invention will be better understood after reading the description of example embodiments given below, which are given for guidance only and are in no way restrictive, with reference to the attached drawings in which:

FIG. 1 diagrammatically illustrates the steps in a process according to the invention,

FIG. 2 is a diagrammatic cutaway perspective view of a particular embodiment of the device according to the invention in an open position

FIG. 3 is a diagrammatic sectional top view of the device in FIG. 2 in a closed position,

FIG. 4 is a diagrammatic perspective sectional view of another particular embodiment of the invention, and,

FIG. 5 is a diagrammatic sectional top view of the device in FIG. 4.

### DETAILED PRESENTATION OF PARTICULAR EMBODIMENT

A process according to the invention uses a thermal, epithermal and fast interrogating neutron flux in order to provoke fission reactions in an object that may contain a fissile material or a fertile material or both. This neutron flux may be obtained using at least one neutron generator operating in pulsed mode and producing fast neutrons, for example with an energy of about 14 MeV, for example using the D-T fusion reaction. An adapted thermalization cell is used to obtain a thermal, epithermal and fast neutron flux. Firstly, the thermal neutrons provoke fission reactions in the missile material, and secondly epithermal and fast neutrons cause fission reactions in the fissile material and in the fertile material.

Furthermore, the use of a measurement method in which a signal is summated after each neutron pulse, is a means of distinguishing the contribution of prompt neutrons produced by thermal fission and the contribution of delayed neutrons produced by thermal, epithermal and fast fission, on the same signal. Only thermal fission contributes to the prompt signal since eqithermal and fast fission reactions are instantaneous, therefore their contribution is drowned in the part of the signal corresponding to interrogating neutrons.

Note that more than one pulsed neutron source can be used to increase the neutron flux and therefore the sensitivity of the measurements.

The number of fast neutron pulses may be very large and for example equal to several million. This depends on the required precision and detection limit.

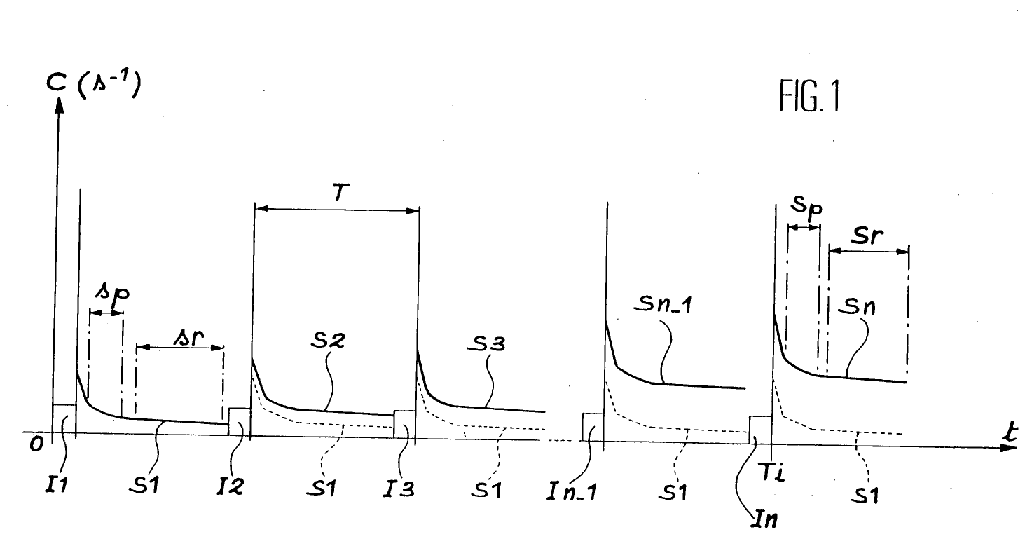

The principle of a process according to the invention using a pulsed source of fast neutrons and a sequential measurement, is illustrated diagrammatically in FIG. 1.

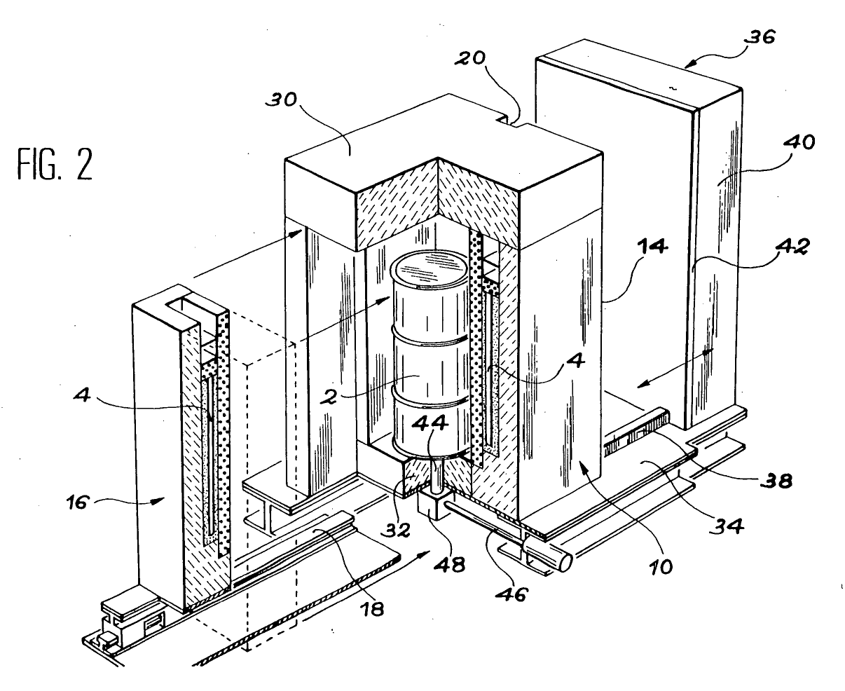

Therefore, the object to be analyzed, for example a radioactive waste package, is irradiated by thermal, epithermal and fast neutrons produced by pulses from the source (and obtained as will be seen later in the description of FIGS. 2 to 5).

FIG. 1 shows the time t on the abscissa and the number of counts per second C(s⁻¹) on the ordinate (on a logarithmic scale).

Neutron pulses I1 (first pulse), I2, I3, . . . , In-1 and In (last pulse) are shown in the figure. The period of the generator is denoted T. The end of the last pulse occurs at an instant denoted Ti. The signal due to a single pulse denoted S1 can also be seen, together with the integrated signals due to two pulses (S2), three pulses (S3), . . . n-1 pulses (Sn-1) and n pulses (Sn).

Therefore, the prompt neutron signals such as sp and delayed neutron signals such as sr emitted after each source pulse are measured, and these signals are accumulated. The contribution Sp of prompt neutrons produced by thermal fission and the contribution Sr of delayed neutrons produced by thermal, epithermal and fast fission, are determined from the integrated signal Sn.

Thus, two items of information Sp and Sr about the residual fuel located in the package can be determined in a single measurement.

According to the invention, these results are coupled with at least two other items of information, for example such as correlations relating the required isotope masses and obtained by calculation programs associated with operating experience in fuel reprocessing plants.

For example, it is assumed that the package contains residual uranium 235, uranium 238, plutonium 239 and plutonium 241. All this information could then written, for example in the form of the following system of equations:

$$\begin{matrix}{S}_{p} = {a}_{1} m ( {}^{235} U ) + {a}_{2} m ( {}^{238} U ) + {a}_{3} m ( {}^{239} PU ) + {a}_{4} m ( {}^{241} Pu ) \\ Sr = {b}_{1} m ( {}^{235} U ) + {b}_{2} m ( {}^{238} U ) + {b}_{3} m ( {}^{239} PU ) + {b}_{4} m ( {}^{241} Pu ) \\ {R}_{1} = \frac{m ( {}^{235} U )}{m ( {}^{238} U )} \\ {R}_{2} = \frac{m ( {}^{241} Pu )}{m {(}^{239} Pu )}\end{matrix}$$

where:
Sp=signal generated by prompt neutrons produced by thermal fission (count/sec.),
Sr=signal generated by delayed neutrons produced by thermal, epithermal and fast fission (count/sec.),
R₁=correlation between the mass m(²¹⁵U) of the uranium 235 isotope and the mass m(²³⁸U) of the uranium 238 isotope.
R₂=correlation between the mass m(²³⁹U) of the plutonium 239 isotope and the mass m(²⁴¹U) of the plutonium 241 isotope.
aᵢ and bᵢ (where i varies from 1 to 4): calibration coefficients in count.s⁻¹.g⁻¹, obtained with a known object (the masses being expressed in grams).

The calibration coefficient a₂ is zero since the fertile material, in the event ²³⁸U, does not participate in the measured signal generated by prompt neutrons.

Solution of this system gives the required masses.

The advantage of this process conform with the invention is due to the fact that the fissile material and the fertile material present in the object to be measured can be “interrogated” simultaneously making use of one or several pulsed sources of fast neutrons, for example 1 or several pulsed generators of 14 MeV neutrons.

Due to its design (examples will be given later), the device used to implement this process can produce a thermal, epithermal and fast flux while amplifying the fast component.

The contrast between the fissile material and the fertile material is thus improved.

Furthermore, the use of an associated sequential acquisition method significantly improves the sensitivity of the measurement of the delayed signal, thus overcoming the poor statistics of delayed fission neutrons. Furthermore, the combination of additional information, for example such as correlations of the different searched isotopes involving mass, molar, atomic or other ratios, is a means of separately quantifying each of the fissile and fertile isotopes present in the waste. Therefore this quantification of each isotope is obtained following a single and unique neutronic measurement on the analyzed object.

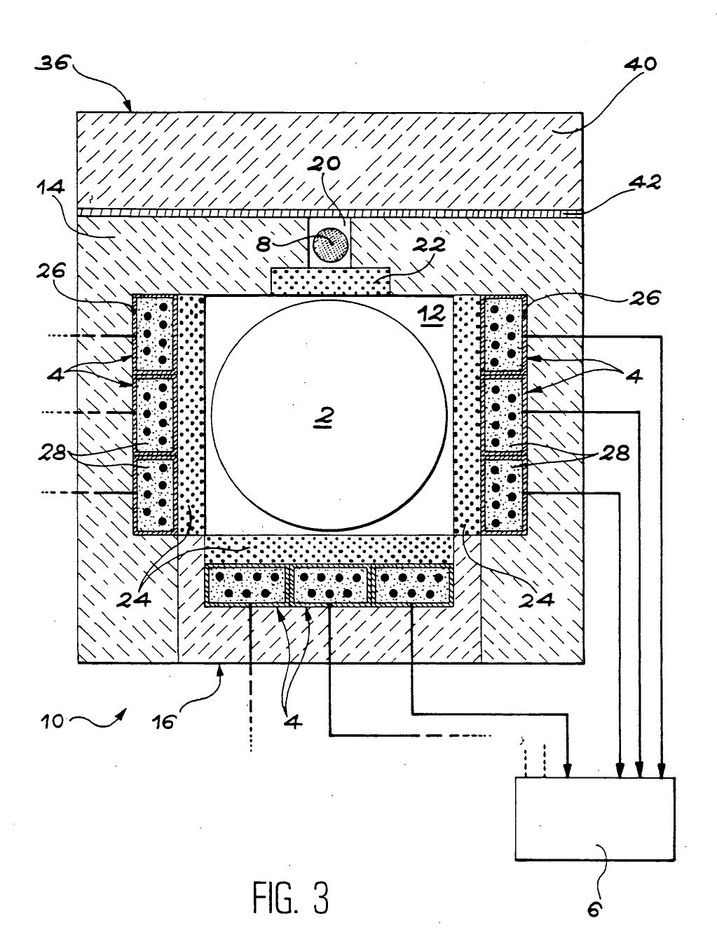

The device according to the invention as shown in the cutaway perspective view in FIG. 2, and in the sectional top view in FIG. 3, is designed to characterize an object, for example a radioactive waste container 2.

This device comprises:
means of irradiating the container 2 by a thermal, epithermal and fast neutron flux,
neutron counting means 4 in order to measure prompt and delayed neutron signals emitted by the container after each pulse and,
signal processing means 6 to process the signals thus measured in order to accumulate these signals, and to use the sum of these signals to determine the contribution Sp of prompt neutrons produced by thermal fission and the contribution Sr of delayed neutrons produced by thermal, epithermal and fast fission, and to determine the mass of each of the fissile and fertile isotopes of the waste as seen above.

The irradiation means comprise a fast neutron generator 8 operating in pulsed mode and a thermalization containment 10 for these fast neutrons in order to obtain the thermal, epithermal and fast neutron flux.

This containment comprises a central area 12 in which the container 2 will be fitted. The shape of this central area is approximately square and it is delimited by a wall 14 made of a moderator material, for example graphite.

Part 16 of this wall is mobile—for example it is installed on rails as shown in FIG. 2—so that the container can be inserted in the central area.

FIG. 2 shows that the containment is open whereas it is closed in FIG. 3 (when the container is irradiated by neutrons).

The part of the wall 14 facing the mobile part 16 comprises a space 20 in which the neutron generator 8 is housed.

The neutron count means are neutronic detection blocks 4 installed in the mobile part 16 of the wall 14 and in the two parts of the wall that are adjacent to this mobile part and are facing each other.

An element 22 made of a multiplier material, for example lead, is inserted between the generator and the central area 12. Similarly, another element 24 made of this multiplier material is inserted between each group of detection blocks 4 and this central area.

Furthermore, each detection block 4 is surrounded by a layer 26 of neutron poison material, for example such as cadmium, and contains neutron counters, for example ³He detectors surrounded by another moderator material 28, for example polyethylene.

The containment is closed at its upper part by a graphite cover 30. It is closed at its lower part by a bottom 32 also made of graphite. This containment is also supported on a base 34, for example made of steel.

The device in FIG. 2 also comprises a wall 36 free to move on rails 38 fitted on base 34 so that it can be moved towards or away from the part of the wall 14 at which the generator 8 is located. This mobile wall 36 is separated from this part in the case shown in FIG. 2, whereas it is in contact with this part in the case shown in FIG. 3.

This mobile part 36 is made of neutron poison and moderator materials; for example, it may be composed of an element 40 made of graphite, coated with a boron carbide layer 42 facing the part of the wall 14 on which the generator is located.

Note that the Last neutrons emitted by the generator 8 towards the mobile wall 36 are thermalized by the graphite element 40 and are absorbed by the boron carbide layer 42 and therefore do not return to the container 2. This mobile wall 36 can be used to adjust the neutron flux.

Means of rotating this container within the central area of the containment may be provided (FIG. 2) in order to obtain uniform irradiation of the container 2 by neutrons. These rotation means may comprise a plate (not shown) on which the container is supported and means of rotating the plate, for example comprising a shaft 44 rigidly fixed to this plate and passing through the bottom 32 of the containment 10, and another shaft 46 rotated by a motor not shown and rotating the shaft 44 by means of gears contained in a box 48.

The block detectors 4 that are used to count the prompt signal and the delayed fission signal are preferably optimized in a known manner to optimize the sensitivity at a given energy.

Obviously, they are connected to electrical power supplies (not shown) necessary for their operation, and are also connected to signal processing means 6 located outside the containment 10.

The lead elements 24 that are placed in front of detection blocks 4 have a radiological shielding function. The measured containers may be very radioactive and in particular may emit high gamma radiation. It is then necessary to protect the counters so that they can be used under optimum conditions.

Neutrons output from the generator 8 enter into the lead elements 22 and 24, and reactions of the (n, 2n) type are applied to them. This can increase the intensity of the interrogating neutron flux by about 60%.

Each interrogating neutron can then interact in two possible ways:

1) The neutron is sufficiently slowed by the moderator materials, the materials in the structures and the object to be measured itself, until they reach thermal energy. It then induces fission reactions on the fissile material (for example ²³⁵U, ²³⁹Pu, ²⁴¹Pu) in the object to be measured.

2) The neutron is slowed but its energy is higher than about 1 MeV. It then induces fission reactions in the object to be measured, not only on the fissile material (for example ²³⁵U, ²³⁹Pu, ²⁴¹Pu), but also on the fertile material (for example ²³⁸U).

Following thermal fission, several fast neutrons (on average 2 to 3 per fission) with an average energy of 2 MeV are emitted instantaneously; these are the prompt neutrons. They are detected in blocks 4 surrounded by neutron poison material, such as cadmium, that absorbs neutrons and makes them sensitive only to fast neutrons. This is a means of eliminating most of the background noise due to neutrons produced by the generator 8, that are thermal at this time of the measurement. However, the prompt neutrons signal is superposed on different background noise terms, the main terms being the “active background noise” (active signal without the contaminant) and the background noise due to passive neutron emission from the contaminant.

The measurement of prompt neutrons cannot start unit the neutrons in the generator have been fully thermalized, since the signal that they induce during a few hundred microseconds after the generator pulse is very high. Consequently, all prompt neutrons produced during this first measurement phase, and particularly neutrons produced by fission reactions induced by fast neutrons from the generator, cannot be detected since they are drowned in the background noise.

The signal due to delayed fission neutrons is superposed on different background noises, the most important of which is the passive neutronic emission from the contaminant. The signal from the delayed neutrons appears to be constant during the scale of a measurement cycle, with a duration of about 10 ms, since their emission time is very long compared with this duration. They start a few hundred milliseconds to several tens of seconds after the fission reaction from which they originate following the β-disintegration of some fission products. Therefore, detected delayed neutrons originated from previous measurement cycles.

Delayed neutrons produced by fission reactions induced by fast neutrons contribute to the delayed neutron signal. Since the emission of a delayed neutron is delayed after the fission reaction that generated it, it is possible to detect delayed neutrons produced by fission reactions induced by fast or epithermal neutrons, or by thermal neutrons.

One important consequence is that the fertile material (for example ²³⁸U) contributes to the delayed neutrons signal, but not to the prompt neutrons signal, since prompt neutrons originating from fast or epithermal fission reactions are not detectable. The effective fission cross section of this isotope at thermal energy is very small compared with the cross section of fissile isotopes, which makes its contribution to the prompt neutrons signal completely negligible since the energy spectrum of the interrogating neutrons is purely thermal during the prompt neutrons measurement.

However, the efficient fission cross section of uranium 238 is of the same order of magnitude as the fission cross section of fissile isotopes beyond 1 MeV. Furthermore, since this isotope may sometimes be present in large proportions in the contaminant, it induces a delayed signal that is not negligible compared with the signal due to fissile isotopes.

A sequential count method is used during acquisition of the signal. Thus, information originating from the contributions of fast and delayed neutrons to the total signal, for example associated with correlations such as the mass ratios of uranium isotopes 235 and 238 and plutonium isotopes 239 and 241, can be used to quantify each of the isotopes mentioned above.

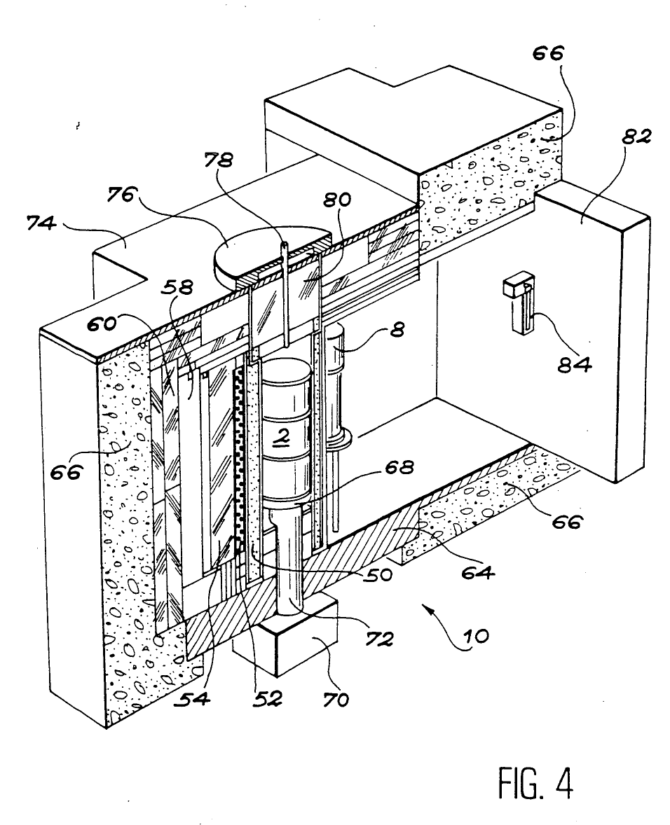

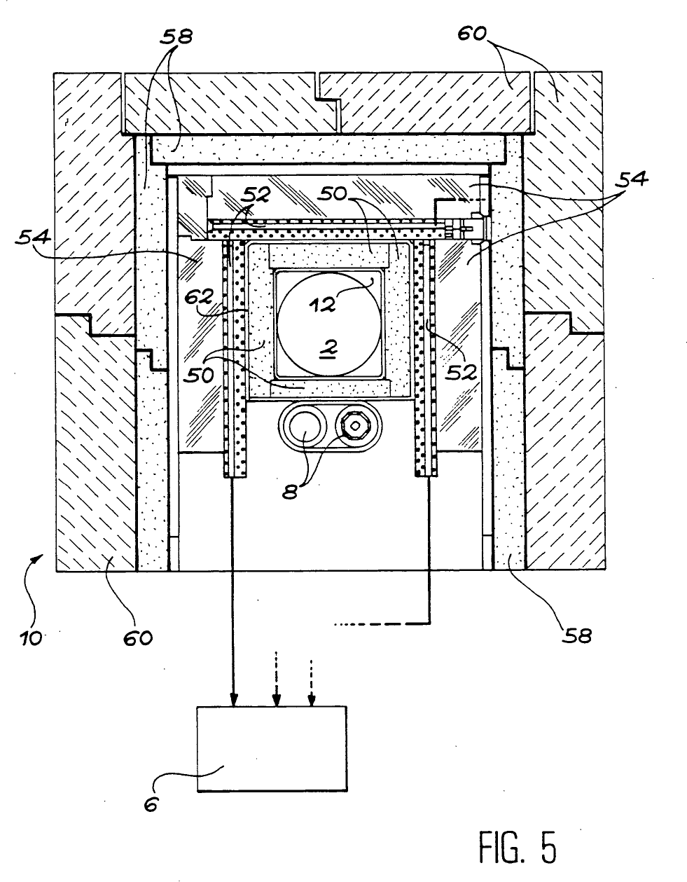

Another device according to the invention is shown diagrammatically in FIGS. 4 and 5. FIG. 4 shows a perspective sectional view of this other device whereas FIG. 5 shows a top sectional view.

The device shown in FIGS. 4 and 5 also includes a containment 10 comprising a central area 12 that for example will receive a radioactive waste container 2 and is delimited by four walls 50 made of a multiplier material, for example such as lead.

Neutron counters 52 are placed outside three of these walls and adjacent to these walls, and are surrounded by a moderator material, for example polyethylene. Two pulsed fast neutron generators 8 are placed outside the fourth wall 50 and adjacent to it.

As will be seen in FIG. 5, walls 54 made of a moderator material, for example graphite, are placed in contact with the neutron counters.

Elements 58 made of an absorbent material, for example borated polyethylene, cover the surfaces of the assembly thus obtained except for the surface on which the neutron generators are located. Furthermore, elements 60 made of a moderator material, for example polyethylene, cover the elements 58 made of an absorbent material.

FIG. 5 also shows the signal processing means 6 that process signals output by neutron counters 52.

Layers (not shown) of a neutron poison material, for example cadmium, cover the neutron detectors.

A sealing layer 62, for example made of a plastic material, surrounds the walls 50.

FIG. 4 shows the base 64 of the containment, which may for example be made of steel. It also shows various thicknesses of concrete 66 surrounding the device.

Means of rotating the container may also be provided, for example comprising the rotating plate 68 that can be rotated by means of an appropriate mechanism 70, though a shaft 72 passing through the base 64.

The upper part of the device in FIGS. 4 and 5 is covered by a steel plate 74. This plate is provided with an opening facing the central area of the containment. This opening is used to place container 2 in this area, and to take it out of the device after the measurements. Furthermore, this opening is closed by a cover 76, for example made of steel, fitted with a gripping system 78. This cover is extended downwards by an element 80 made of a moderator material, for example polyethylene.

FIG. 4 also shows a fixed wall 82 made of concrete that is located facing the neutron generators 8 and that is separated from them by a space. The face of this wall 82 that is opposite the generators is fixed to a flux monitor 84 designed to determine the number of neutrons emitted by the two neutron generators 8.

Appropriate means (not shown) may be provided opposite the other face of the concrete wall 82 capable of penetrating into this device through openings (not shown), for maintenance of the device shown in FIGS. 4 and 5.

1. Device for analyzing an object (2) that contains fissile material and fertile material, the fissile material comprising M fissile isotopes and the fertile material comprising N fertile isotopes, where M and N are integer numbers equal to at least 1, said device comprising:
means (8, 10) for irradiating the object by a neutron flux consisting of thermal, epithermal and fast neutrons, the thermal neutrons being effective to cause fissions in the fissile material and the epithermal and fast neutrons being effective to cause fissions in the fissile material and in the fertile material, said means for irradiating consisting essentially of one or more sources of fast neutrons operable in pulsed mode and means of thermalizing fast neutrons supplied by said one or more sources of fast neutrons to provide said neutron flux consisting of said thermal, epithermal and fast neutrons,
means (4, 52) for counting neutrons and for measuring prompt and delayed neutronic signals emitted by the object after each pulse of fast neutrons supplied from said one or more fast neutron sources, and
means (6) for accumulating measured prompt and delayed neutronic signals and for obtaining the sum of all such signals, and for determining the contribution Sp of prompt neutrons produced by the thermal fissions and the contribution Sr of delayed neutrons produced by the thermal, epithermal and fast fissions.

2. Device according to claim 1, in which the thermalization means comprises a containment (10) that includes a central area (12) in which the object (2) will be placed and in which at least three sides are delimited by a thickness (14, 60) of moderator material, the fast neutron source (8) being placed in a fourth side of this containment and the neutron counting means (4, 52) being placed on the three sides between the central area and the thickness of moderator material, a thickness of neutron multiplier material (22, 24, 50) being provided between the central area and the fast neutron source and between the central area and neutron counting means.

3. Device according to claim 2, in which each neutron counting means is also surrounded by a thickness (26) of neutron poison material.

4. Device according to claim 2, in which each neutron counting means is also surrounded by a moderator material (28).

5. Device according to claim 2, also comprising a wall (36) made of neutron poison and moderator materials that delimits the fourth side of the containment, a corresponding thickness (223) of the multiplier material being between this wall (36) and the central area (12).

6. Device according to claim 2, also comprising means (46, 48, 68, 70, 72) of rotating the object (2) within the central area of the containment.

7. A device according to claim 1, in which the means of thermalizing comprises a containment that includes a central area in which the object will be placed and in which at least three sides are delimited by a thickness of moderator material, the fast neutron source being placed in a fourth side of this containment and the neutron counting means being placed between the central area and the thickness of moderator material, a thickness of neutron multiplier material being provided between the central area and the fast neutron source, the device also comprising a wall at least made of a neutron poison material that delimits the fourth side of the containment, a corresponding thickness of the multiplier material being between this wall and the central area.

8. A device according to claim 1, wherein M equals 3 and N equals 1.

9. A device according to claim 8, wherein the 3 fissile isotopes are uranium 233, uranium 235 and plutonium 239 and the fertile isotope is uranium 238.

10. A device according to claim 2 wherein the neutron multiplier material is Pb.

11. A. device according to claim 1, further comprising means for determining the quantity of each of the M+N isotopes from the contribution Sp, the contribution Sr and at least M+N-2 additional items of information related to the quantities of the M+N isotopes.

12. A device according to claim 11, said combination Sp and combination Sr being expressed as linear combinations of the quantities of said M+N isotopes, wherein coefficients of said linear combinations are determinable beforehand by calibration.

13. A device according to claim 1, said object being a radioactive waste package.

14. A device according to claim 8, wherein the 3 fissile isotopes are uranium 235, plutonium 239 and plutonium 241 and the fertile isotope is uranium 238.
